(19) United States
(12) Patent Application Publication
(10) Pub. No.: US 2007/0195729 A1
(43) Pub. Date: Aug. 23, 2007

(54) System and method for self-configuring adaptive wireless router network

(76) Inventors: Hongbing Li, Belle Mead, NJ (US); King Huang, East Brunswick, NJ (US); Shiwen Chen, Marlboro, NJ (US); Harumine Yoshiba, Kanagawa-ken (JP)

Correspondence Address: GREGORY A. STOBBS, 5445 CORPORATE DRIVE, SUITE 400, TROY, MI, 48098, US

(21) Appl. No.: 11/357,866

(22) Filed: Feb. 17, 2006

(51) Int. Cl. H04Q 7/00

(52) U.S. Cl. 370/328

(57) ABSTRACT

An automated and distributed method is provided for configuring addressing of nodes in a wireless network, where the nodes includes at least one wireless interface and a network interface which connects to an external network. Briefly, the method includes: assigning a wireless network address to the wireless interface associated with the node; assigning another external network address to the external network interface associated with the node in a manner where a subnet identifier of the network address for the external interface correlates to a host identifier of the network address for the wireless network. The method may further include assigning further network addresses to one or more network devices which share the same subnetwork as the external network interface of the node.

### FIELD

The present disclosure relates to mobile ad-hoc networks and, more particularly, to an automated method for configuring a node in a wireless network to interface with an external network

### BACKGROUND

In today's evolving mobile security requirements, a key question is how to rapidly deploy sensors, surveillance cameras, and detection equipment across a small geographic location to form a “community” of security sensors that would monitor the data they collect, and make available this data in real time to multiple command and control entities. This community of mobile security sensors can enhance public safety, improve transportation systems and infrastructure, and improve public service delivery. Such mobile security requirements may be met through the use of mobile ad-hoc networks.

Mobile ad-hoc networks allow computer to form wireless peer-to-peer connections and create a network that allow devices to communicate with each other. Each node within the network can serve as router and forward data traffic between sending and receiving devices. To date, some routing protocols can successfully solve the routing problems among the wireless nodes of the mobile ad-hoc networks. Furthermore, some routing protocols even consider auto-configuration of IP addresses for the wireless interface of each node. However, known protocols lack efficient methods for bridging the gap between nodes in the wireless network and devices residing in networks outside of the wireless network. Manually configuring the IP address assignment of the wired Ethernet interfaces and IP address assignment for the client devices. For two devices to communicate within the network, such routing configuration is essential.

Therefore, it is desirable to provide an automated method for configuring a node in a wireless network to interface with devices in an external network. The statements in this section merely provide background information related to the present disclosure and may not constitute prior art.

### SUMMARY

An automated and distributed method is provided for configuring addressing of nodes in a wireless network, where the nodes includes at least one wireless interface and a network interface which connects to an external network. Briefly, the method includes: assigning a wireless network address to the wireless interface associated with the node; assigning another external network address to the external network interface associated with the node in a manner where a subnet identifier of the network address for the external interface correlates to a host identifier of the network address for the wireless network. The method may further include assigning further network addresses to one or more network devices which share the same subnetwork as the external network interface of the node.

Further areas of applicability will become apparent from the description provided herein. It should be understood that the description and specific examples are intended for purposes of illustration only and are not intended to limit the scope of the present disclosure.

### DRAWINGS

FIG. 1 is a diagram of an exemplary mobile ad-hoc network;

FIG. 2 is a flowchart illustrating an automated method for configuring a node in a wireless network to interface with an external network;

FIG. 3 is a flowchart illustrating a technique for dynamically assigning an IP address to a wireless interface of a wireless node;

FIG. 4 is a diagram illustrating how data packets may be routed from one subnet to another subnet in accordance with the principles of the present disclosure; and

FIG. 5 is a diagram illustrating an alternative technique for routing data packets from one subnet to another subnet in accordance with the principles of the present disclosure.

The drawings described herein are for illustration purposes only and are not intended to limit the scope of the present disclosure in any way.

### DETAILED DESCRIPTION

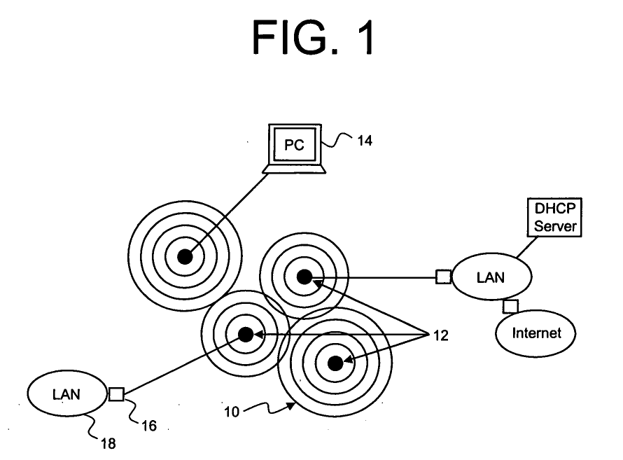

FIG. 1 illustrates an exemplary ad-hoc network environment 8. At its core, the ad-hoc environment includes a mobile wireless network 10. The wireless network 10 is comprised generally of a plurality of devices 12 which are operable to communicate with each other over wireless connections. Thus, each device of the wireless network is configured with at least one wireless interface. These devices 12 are herein referred to as nodes of the wireless network.

Some of the wireless nodes 12 may be further configured with one or more interfaces for connecting to devices outside of the wireless network 10. In an exemplary embodiment, the interface is an Ethernet port which supports a wired connection to an external device. In some instance, a standalone computing devices 14 may be directly connected to the external interface of a wireless node. In other instances, a hub (or switch) 16 of another local area network 18 may be connected to the external interface of a wireless node 12. While the following description is provided with reference to an Ethernet interface, it is readily understood that other types of external interfaces are contemplated by this disclosure.

The wireless nodes may provide an ad hoc routing function between devices deployed in certain ad hoc applications such as field surveillance. When deployed in an ad hoc fashion, some of the devices may be standalone whereas other may be connected to each other in an isolated LAN configuration. In this scenario, the wireless nodes serve to interconnect these types of devices to each other. It is envisioned that the wireless nodes may be integrated with or embedded into other application devices (e.g., cameras) as well. A correct addressing scheme is essential for routing data packets amongst the devices in this ad hoc environment. First, the wireless routing nodes must be properly assigned addresses in a distributed way without the use of a DHCP server so that no single point of failure will happen. Second, each of the devices outside of the wireless network must also be assigned addresses which are unique within the entire environment.

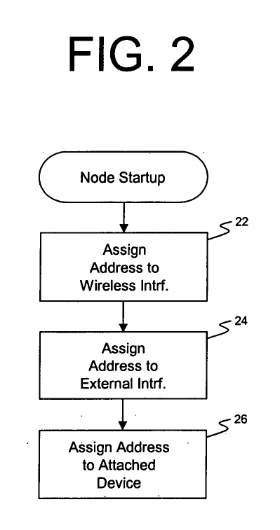

An automated and distributed method for configuring a node in a wireless network to interface with an external network is further described in relation to FIG. 2. Any node joining the wireless network will need to determine a network address for its wireless interface as indicated at 22. For illustration purposes, the network address is an Internet Protocol (IP) address, but other network address schemes are also contemplated by this disclosure. To support self-configuring within the network, a subnet number (e.g., 192.168.A.0/24, where A is a number between 1 and 254) is assigned for use by all of the wireless interfaces in the wireless network. Each node can dynamically determine an available host number and then construct a unique network address by combining the subnet number with the host number.

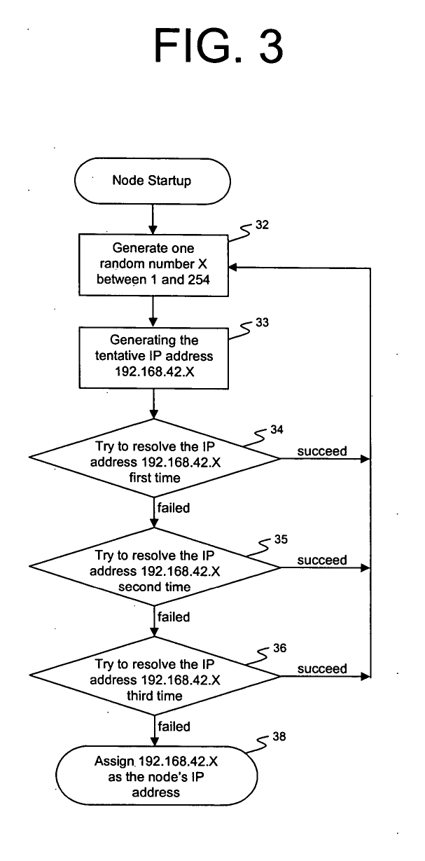

FIG. 3 illustrates an exemplary technique for dynamically assigning an IP address to a wireless interface. First, a number X between 1 and 254 is randomly generated as indicated at 32. An IP address is then generated at 33 by using the randomly generated number as a host identifier, thereby yielding a tentative IP address (e.g., 192.168.A.X). To ensure a unique address assignment, the other nodes in the wireless network are probed for a matching address. To do so, a resolution query is propagated through the network multiple times as shown at steps 34, 35, and 36. If the network address is currently assigned to another node in the wireless network, then the process is repeated. When the network address is not currently assigned to another node, then it may be used by the requesting node. It is envisioned that this process may be repeated for each wireless interface associated with a given node.

With continued reference to FIG. 2, a network address is then assigned at 24 to the Ethernet interface associated with the joining node. The assigned subnet number for the Ethernet address has a one-to-one mapping relation with the network address for the wireless interface. For example, the host identifier for the wireless interface address is assigned as the subnet identifier of the Ethernet address. In other words, the IP address for the Ethernet interface may be assigned as 10.A.X.1, where X is the same host identifier as found in the IP address for the wireless interface. Other means for uniquely correlating the subnet identified of the Ethernet address to the host identifier of the wireless interface address are also contemplated by this disclosure. Since each wireless interface in the network has a unique host identifier as described above, this ensures that no two Ethernet interface will be assigned the same IP address.

As indicated at 26, the joining node is further able to assign network addresses to one or more network devices which share a subnetwork with the Ethernet interface of the node. In other words, the joining node is able to assign network addresses to a standalone computing device which directly connects to the Ethernet interface or to network devices (e.g., an Ethernet hub or switch) in a local area network which is connected to the Ethernet interface. To provide automated assignment of these addresses, the joining node may be configured with a Dynamic Host Configuration Protocol (DHCP) server which runs on the Ethernet interface.

Network addresses assigned by the joining node remain coordinated with the network address assigned to its wireless interface. Continuing with the example set forth above, the DHCP server will assign IP addresses in the range of 10.A.X.2 through 10.A.X.254, where X is the host identifier as found in the IP address for the wireless interface. The DHCP server will also advise an attached device that it should use 255.255.255.0 as its subnet mask, 10.A.X.255 as its broadcast address and 10.A.X.1 as the router/gateway address. Since the subnet identifier for these external network addresses correlates to the host identifier for the wireless interface of the node and the host identifier assigned to the wireless interface is uniquely resolved through the wireless network, any two subnets that connect to different wireless nodes will be assigned different subnet identifiers, such that no two devices found in these subnets will have the same network address. For clarity, nodes configured in this manner will be referred to below as external routing nodes.

In operation, data packets are routed amongst the wireless nodes using an ad hoc protocol (e.g., LUNAR, AODV, DSR, etc.) resident on each of the wireless nodes. Data packets can also be routed from the nodes in the wireless network through an external routing node to devices accessible through the external interface of the external routing node. Likewise, data packets can be routed from these external devices though the external routing node to the other nodes of the wireless network. Moreover, since more than one wireless node may be configured as an external routing node, data packets may be routed from a device in one external network through the wireless network to a device residing in another external network.

In a normal routing mode, an external routing node assumes that devices accessible through its external interface have not been assigned network addresses. Therefore, the external routing node uses its DHCP server and the mechanism described above to assign network addresses to these devices. More specifically, the IP address for the wireless interface of the external routing node is self-configured as 192.168.A.X and the IP address for the Ethernet interface is self-configured as 10.A.X.1. The default gateway for the external routing node will be set to the wireless interface 192.168.A.X. This means all the routing requests will be handled by the applicable ad hoc routing algorithm residing on the node. The external routing node will not only claim it can resolve IP addresses 192.168.A.X and 10.A.X.1, but will also claim it can resolve all IP addresses in the subnet 10.A.X.0/24, so that all the address resolution requests to 192.168.A.X, 10.A.X.0/24 will be returned positive to the solicitation node.

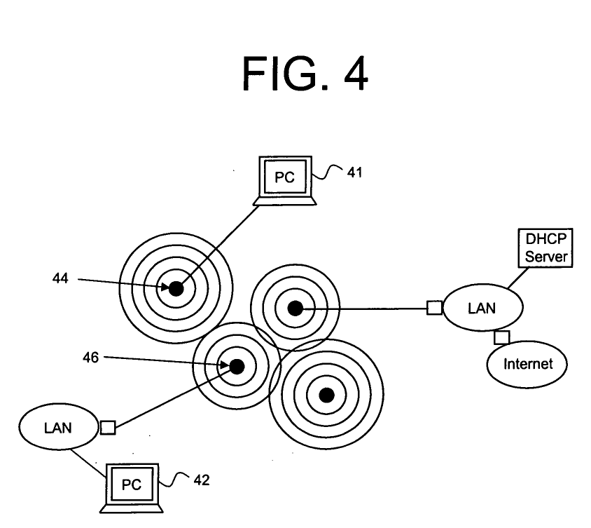

For instance, a device 41 having an address 10.A.X.18 needs to communicate with a device 42 having an address 10.A.Y.21 in another subnet as shown in FIG. 4. The device 41 first sends data packets to its local wireless routing node 44 according to the default gateway setting which is obtained during the DHCP process. The wireless routing node 44 having a 10.A.X.1 address for its external interface and a 192.168.A.X address for its wireless interface. A second wireless routing node 46 in turn sends routing replies for the destination device 42. The second wireless routing node 46 having a 10.A.Y.1 address for its external interface and a 192.168.A.X address for its wireless interface. Accordingly, data packets are forwarded from the first wireless routing node to the second wireless node which further forwards them to the destination device 42.

Alternatively, when devices accessible through the external interface of an external routing node have already been assigned network addresses, the external routing node may function in a gateway mode. In a gateway mode, the external routing node resolves its wireless interface address in the manner described above. However, the network address for its external interface is either configured in a manual fashion or assigned by a DHCP server residing on the external network. In the gateway mode, the DHCP server residing on the external routing node is not itself running.

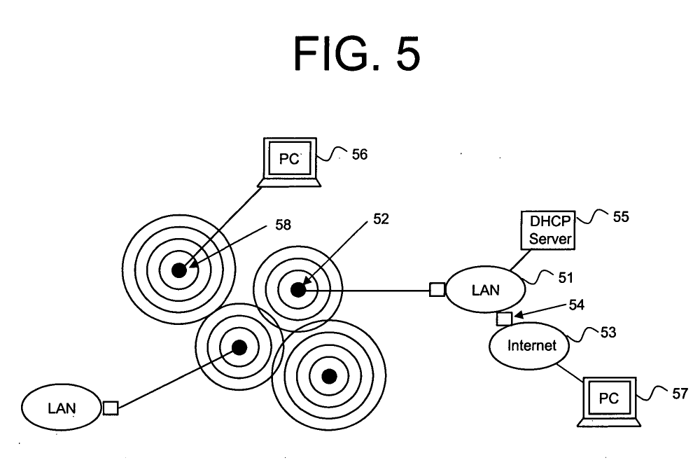

Referring to FIG. 5, a local area network 51 connected to wireless routing node 52 may be further connected to another network 53 (e.g., the Internet). In this example, the Ethernet interface of the wireless routing node 52 may be configured as E.F.G.H. by assignment from an external DHCP server 55 residing on LAN 51. Another device 54 in the LAN 51 is configured by the DHCP server 55 to serves as the default router which connects the LAN 51 to the other network 53. One prerequisite for the subnet identifier for the LAN 51 is that it shall not have the prefix of 10.A.0.0/16 nor 192.168.A.0/24.

When a device 56 having an address 10.A.X.18 needs to communicate with a device 57 having an address 150.1.1.21 in the Internet, data packets are routed as follows. First, the source device 57 sends the packets to its local wireless router 58 (10.A.X.1) according to the default gateway setting which is obtained during the DHCP process. The local wireless router 58 sends the routing request for the destination device. A second wireless node 52 operating in a gateway mode in turn sends a routing reply for the destination device. The second wireless node 52 having an E.F.G.H. address for its external address and a 192.168.A.Y address for its wireless interface. Accordingly, data packets are forwarded from the first wireless routing node 58 to the second wireless routing node 52 which further forwards them to an upper router 54 whose address is E.F.G.L. Data packets are forward further still by the upper router 54 to the destination device 57.

The automated technique described above creates an intelligent wireless network for connecting surveillance sensors as well as other devices in a scalable mobile architecture suitable for many different applications. It also can be used to support a mobile community of surveillance sensors that is self-configuring, self-discovering, and self-organizing. Such networks can be redundant and fault tolerant. If any router fails, others in the community will continue to function and reroute traffic around the failure. Furthermore, this solution allows ad-hoc devices to join or drop off the network. For example, an authenticated device entering the wireless network can add security features and functionality, such as additional video or motion sensors.

The following description is merely exemplary in nature and is not intended to limit the present disclosure, application, or uses.

What is claimed is:

1. An automated method for configuring a node in a wireless network to interface with an external network, comprising:
randomly determining a host identifier for the node;
constructing a network address for a wireless interface associated with the node using the host identifier;
assigning the network address to the wireless interface when the network address is not currently assigned to another node in the wireless network; and
assigning another network address to an external interface associated with the node, where a subnet identifier of the network address for the external interface correlates to a host identifier of the network address for the wireless interface.

2. The method of claim 2 further comprises generating a different network address for the wireless interface when the network address is currently assigned to another node in the wireless network.

3. The method of claim 1 further comprises assigning further network addresses to one or more network devices which share a subnetwork with the external interface of the node, where the further network addresses are coordinated with the network address for the wireless interface.

4. The method of claim 3 wherein assigning further network addresses in a manner where a subnet identifier of the further network addresses correlates to a host identifier of the network address for the wireless interface.

5. The method of claim 1 wherein the network address for the wireless interface and the network address for the external interface are further defined as IP addresses.

6. The method of claim 1 wherein the external interface is further defined as an Ethernet port associated with the node.

7. The method of claim 3 wherein assigning further network addresses employs a dynamic host configuration protocol residing on the node.

8. An automated method for configuring a node in a wireless network to interface with an external network, comprising:
assigning a network address to a wireless interface associated with the node;
assigning another network address to an external interface associated with the node; and
assigning further network addresses to one or more network devices which share a subnetwork with the external interface of the node, where the further network addresses are coordinated with the network address for the wireless interface.

9. The method of claim 8 wherein assigning a network address further comprises
generating a random number;
generating the network address using the random number;
probing other nodes in the wireless network for a matching network address; and
assigning the network address to the wireless interface when the network address is not currently assigned to another node in the wireless network.

10. The method of claim 9 further comprises generating a different network address when the network address is currently assigned to another node in the wireless network.

11. The method of claim 8 wherein assigning another network address to an external interface in a manner where a subnet identifier of the network address for the external interface correlates to a host identifier of the network address for the wireless interface.

12. The method of claim 8 wherein assigning further network addresses in a manner where a subnet identifier of the further network addresses correlates to a host identifier of the network address for the wireless interface.

13. The method of claim 8 wherein the network address for the wireless interface, the network address for the external interface and the further network addresses are further defined as IP addresses.

14. The method of claim 8 wherein the external interface is further defined as an Ethernet port associated with the node.

15. The method of claim 8 wherein assigning further network addresses employs a dynamic host configuration protocol residing on the node.

16. A method for interfacing devices in an ad hoc network environment, comprising:
positioning a first wireless node of a wireless network proximate to a first isolated device;
connecting the isolated device to an external interface of the first wireless node; and
assigning a network address to the first isolated device, where the network address is assigned by the wireless node and is coordinated with a network address assigned to a wireless interface of the first wireless node.

17. The method of claim 16 further comprises routing data packets from the first isolated device via the first wireless node to other wireless node in the wireless network.

18. The method of claim 16 further comprises routing data packets from other wireless nodes in the wireless network via the first wireless node to the first isolated device.

19. The method of claim 16 wherein the first isolated device is further defined as either a standalone computing device or a network routing device of a local area network.

20. The method of claim 16 further comprises positioning a second wireless node proximate to a second isolated device; connecting the second isolated device to an external interface of the second wireless node; and assigning a network address to the second isolated device, where the network address is assigned by the second wireless node and is coordinated with a network address assigned to a wireless interface of the second wireless node.

21. The method of claim 20 further comprises routing data packets from the first isolated device via the wireless network to the second isolated device.

22. The method of claim 16 further comprises routing data packets amongst wireless nodes in the wireless network using an ad hoc routing protocol resident on each of the wireless nodes.

23. The method of claim 16 further comprises
randomly determining a host identifier for the first wireless node;
constructing a network address for the wireless interface associated with the first wireless node using the host identifier;
assigning the network address to the wireless interface when the network address is not currently assigned to another node in the wireless network.

24. The method of claim 16 further comprises assigning another network address to the external interface associated with the first wireless node, where a subnet identifier of the network address for the external interface correlates to a host identifier of the network address for the wireless interface.
